(19) United States
(12) Patent Application Publication
(10) Pub. No.: US 2014/0055257 A1
(43) Pub. Date: Feb. 27, 2014

(54) GEAR SHIFT PROMPTING SYSTEM AND GEAR SHIFT PROMPTING METHOD THEREOF

(71) Applicants: MITAC INTERNATIONAL CORP., Taoyuan County (TW); MITAC RESEARCH (SHANGHAI) LTD., Shanghai City (CN)

(72) Inventor: WEN-HUA LIU, Shanghai City (CN)

(73) Assignees: MITAC RESEARCH (SHANGHAI) LTD., Shanghai City (CN); MITAC INTERNATIONAL CORP., TAOYUAN COUNTY (TW)

(21) Appl. No.: 13/755,920

(22) Filed: Jan. 31, 2013

(30) Foreign Application Priority Data
Aug. 23, 2012 (CN) 201210302612.7

(51) Int. Cl. B60Q 1/00

(52) U.S. Cl. CPC B60Q 1/00
USPC 340/456

(57) ABSTRACT

A gear shift prompting system and a gear shift prompting method are provided. The gear shift prompting system includes a navigation module and a control module, wherein the control module generates a real-time gear shift signal to control a vehicle gear shift. The navigation device includes a prompting module and a processing module. The processing module receives the real-time gear shift signal and controls the prompting module to audio-broadcast an audio message of a current gear shift corresponding to the real-time gear shift signal or controls the prompting module to generate a graphical illustration message of the current gear shift based upon the real-time gear shift signal.

### CROSS-REFERENCE TO RELATED APPLICATION

This application claims the benefit of China Patent Application No. 201210302612.7, filed on Aug. 23, 2012, in the State Intellectual Property Office of the People's Republic of China, the disclosure of which is incorporated herein in its entirety by reference.

### BACKGROUND OF THE INVENTION

1. Field of the Invention

The present invention relates to a prompting system, and more particularly to a gear shift prompting system and a gear shift prompting method thereof that capable of allowing a user to receive a gear shift prompting message when the user switches gear shifts and capable of incorporating with a traffic message channel to provide correspondingly gear shifts to the user.

2. Description of the Related Art

A transmission box of an automobile usually has many different rotational speeds/torque conversion ratios that are so called “gear shift” to provide a user to switch the rotational speeds/torques under different driving speeds. For example, when the automobile starts moving, it may need low rotational speed and high torque. While in high speed driving, it may need high rotational speed and low torque.

As the technology is advanced, the transmission box can be divided into manual operation and automatic operation based upon operating manners, including a manual transmission (MT) and an automatic transmission (AT). In another word, the MT needs labor force to manually operate to switch gear shifts; and the AT is to switch gear shifts by mechanical operation, wherein a continuously variable transmission (CVT) capable of continuously regulating the rotational speeds/torque conversion ratio is recently presented to the public and also one of the AT.

Since the amount of the automobile is rapidly increased, drivers in practice are more and more. For a driver in practice, understanding gear shift switching inside the automobile is a primary issue while driving the automobile. In addition, drivers who frequently drive automobiles may be certainly familiar with gear shift switching. However, when the driver sits an unfamiliar automobile, the driver must be firstly familiar with different gear shift to perform switching.

Therefore, designing a gear shift prompting system and a gear shift prompting method thereof to prevent the driver from wrongly switching gear shifts to cause accidents due to confusion or the driver that is unfamiliar with gear shifts becomes an importation issue that needs to be overcome in the market application.

### SUMMARY OF THE INVENTION

In view of the shortcomings of the prior art, the inventor(s) of the present invention based on years of experience in the related industry to conduct extensive researches and experiments, and finally developed a gear shift prompting system and a gear shift prompting method thereof as a principle objective to provide gear shift messages to a driver such that after the driver switches gear shifts, fuel consumption of a vehicle can be reduced, and mechanical consumption may be decreased to the minimum.

According to an objective of the invention, a gear shift prompting system is provided and includes a navigation device and a control module. The navigation module includes a prompting module and a processing module. The control module generates a real-time gear shift signal and controls the prompting module to audio-broadcast an audio message of a current gear shift corresponding to the real-time gear shift signal or controls the prompting module to display a graphical illustration message of the current gear shift.

The navigation device obtains a piece of front traffic information through a traffic message channel (TMC).

The processing module analyzes a corresponding gear shift parameter based upon the piece of front traffic information, and controls the prompting module to audio-broadcast an audio message of a corresponding gear shift corresponding to the corresponding gear shift parameter or display a graphical illustration message of the corresponding gear shift on the prompting module.

The processing module transmits a front traffic signal to an external database based upon the piece of front traffic information, and the external database receives the front traffic signal to analyze a corresponding gear shift parameter, and the external database transmits the corresponding gear shift parameter back to the processing module.

The processing module controls the prompting module to audio-broadcast an audio message of a corresponding gear shift corresponding to the corresponding gear shift parameter based upon the corresponding gear shift parameter or display a graphical illustration message of the corresponding gear shift on the prompting module.

The processing module transmits a front traffic signal to an external database through a general packet radio service (GPRS) based upon the piece of front traffic information.

The external database receives the front traffic signal to analyze a corresponding gear shift parameter and transmits the corresponding gear shift parameter back to the processing module, and the processing module controls the prompting module to audio-broadcast an audio message of a corresponding gear shift corresponding to the corresponding gear shift parameter or display a graphical illustration message of the corresponding gear shift on the prompting module based upon the corresponding gear shift parameter.

The control module is connected to the navigation device through a controller area network (CAN) bus and controls the navigation device to audio-broadcast the audio message of the current gear shift corresponding to the real-time gear shift signal or controls the prompting module to display the graphical illustration message of the current gear shift.

According to the objective of the invention, a gear shift prompting method is provided. The gear shift prompting method is suitable for a gear shift prompting system. The gear shift prompting system includes a navigation device, a control module and a processing module. The gear shift prompting method comprises the following steps: generating a real-time gear shift signal to change a vehicle gear shift by utilizing the control module; receiving the real-time gear shift signal through the processing module; and controlling the prompting module to audio-broadcast an audio message of a current gear shift corresponding to the real-time gear shift signal or controlling the prompting module to display a graphical illustration message of the current gear shift based upon the real-time gear shift signal by utilizing the processing module.

The gear shift prompting system and the gear shift prompting method thereof according to the invention can use the navigation device to display and notify the driver that the gear shift is being switching so that the driver can quickly and accurately understand and is familiar with the gear shift switching of the automobile. At the same time, front traffic information can be obtained real-time through the TMC by utilizing the navigation device, and the driver is notified to shift original gear shifts to properly corresponding gear shifts so that fuel consuming and mechanical consumption of the automobile can be reduced to the minimum, and driving risk can be reduced as well.

### BRIEF DESCRIPTION OF THE DRAWINGS

FIG. 1 is a block diagram of a gear shift prompting system according to a first embodiment of the invention;

FIG. 2A is a first schematic diagram of a gear shift prompting system according to a first embodiment of the invention;

FIG. 2B is a second schematic diagram of a gear shift prompting system according to a first embodiment of the invention;

FIG. 3 is a flowchart of a gear shift prompting method according to a first embodiment of the invention;

FIG. 4 is a block diagram of a gear shift prompting system according to a second embodiment of the invention;

FIG. 5 is a first schematic diagram of a gear shift prompting system according to a second embodiment of the invention;

FIG. 6 is a second schematic diagram of a gear shift prompting system according to a second embodiment of the invention; and

FIG. 7 is a flowchart of a gear shift prompting method according to a second embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

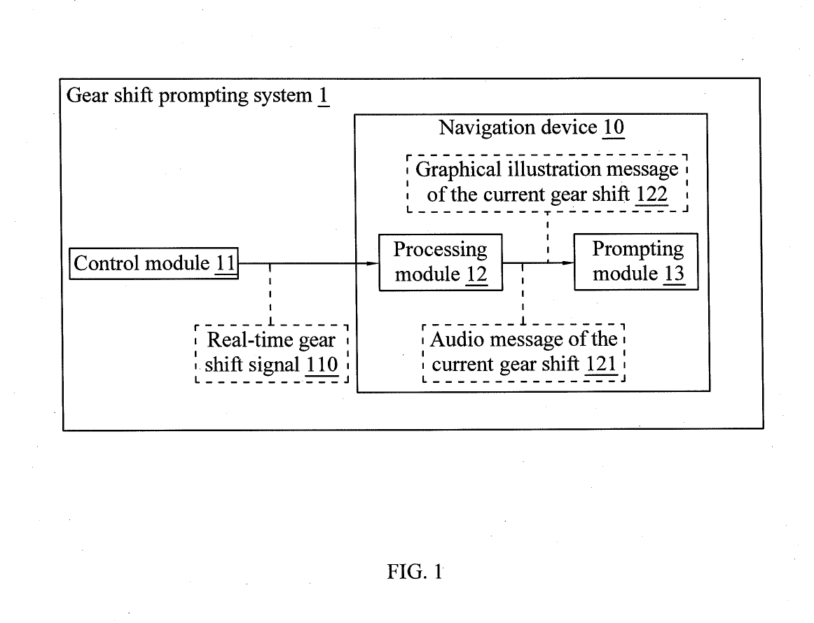

With reference to FIG. 1 for a block diagram of a gear shift prompting system according to a first embodiment of the invention is depicted. As shown in FIG. 1, the gear shift prompting system 1 can include a navigation device 10 and a control module 11. The navigation device 10 includes a processing module 12 and a prompting module 13. The control module 11 can generate a real-time gear shift signal 110 to control or change the driving gear shifts of an automobile and can be divided into two modes of automatic mode and manual mode based upon operating manners. The control module 11 can, but not limited to, be transmissions of a manual transmission (MT), an automatic transmission (AT), a semi-automatic transmission, a continuously variable transmission (CVT) or a dual clutch transmission (DCT). The processing module 12 can be a central processing unit (CPU) or a micro-processing unit and receive the real-time gear shift signal 110 and controls the prompting module 13 to audio-broadcast an audio message of a current gear shift 121 corresponding to the real-time gear shift signal 110 based upon the real-time gear shift signal 110 or controls the prompting module 13 to display a graphical illustration message of a current gear shift 122.

The control module 11 can also be connected to the navigation device 10 through a controller area network (CAN) bus and controls the prompting module 13 to audio-broadcast the audio message of a current gear shift 121 corresponding to the real-time gear shift signal 110 through the CAN bus or controls the prompting module 13 to display a graphical illustration message of the current gear shift 122.

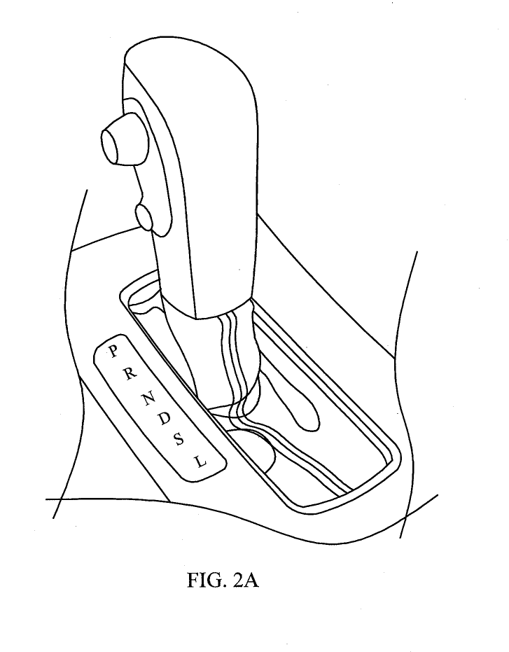

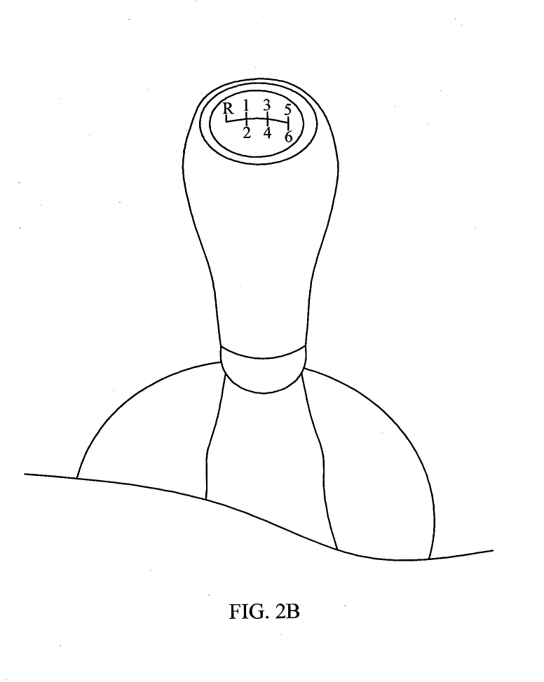

With reference to FIG. 2A and FIG. 2B for a first schematic diagram and a second schematic diagram of a gear shift prompting system according to a first embodiment of the invention are depicted. As shown in figures, FIG. 2B is a manual gear shift lever, and FIG. 2A is an automatic gear shift lever. Generally, the gear shift on the manual gear shift lever is divided into five or six gear shifts, and a Reverse gear shift is set as a Neutral gear shift. The automatic gear shift lever can have six gear shifts such as P, R, N, D, S or L gear shift. For example, P gear shift is selected to lock the output shaft of the transmission to stop the automobile. R gear shift is selected to drive the automobile for reverse forwarding. N gear shift is selected to allow the transmission to enter the neutral gear shift and can be used during the actuation. Further, when the automobile is running on a bad shape road, such as the road covered by snow, or on a gentle ascent or a gentle descent, S gear shift or L gear shift can be selected.

Therefore, when a driver switches the foregoing gear shifts, the processing module is utilized to receive the real-time gear shift message generated by the control module through the gear shift prompting system of the invention and controls the prompting module based upon the real-time gear shift signal to audio-broadcast or display a current audio signal or a graphical illustration signal corresponding to the real-time gear shift signal.

In another word, when the driver switches D gear shift to S gear shift, the audio signal can be audio-broadcasted directly through the prompting module so that the driver can be prompted that the current gear shift is S gear shift. When the driver switches P gear shift to N gear shift, the graphical illustration signal can be displayed through the prompting module of the invention so that the driver can be prompted that the current gear shift is N gear shift. Accordingly, the user can further allow the navigation system to obtain the audio message or the graphical illustration message of the current gear shift through the gear shift prompting system of the invention based upon the real-time gear shift signal generated by switching gear shifts from the driver, thereby understanding which gear shift is currently set for the driver. It should be noted that the foregoing depiction of the gear shift is only the example. People who have ordinary skill in the art would know that the invention can be applied in the modification of different types, structures, allocation, proportion and components.

A concept of the gear shift prompting method of the invention has been explained during the process of depicting the gear shift prompting system of the invention. However, to further understand the concept, the gear shift prompting method is further depicted in the following flowchart.

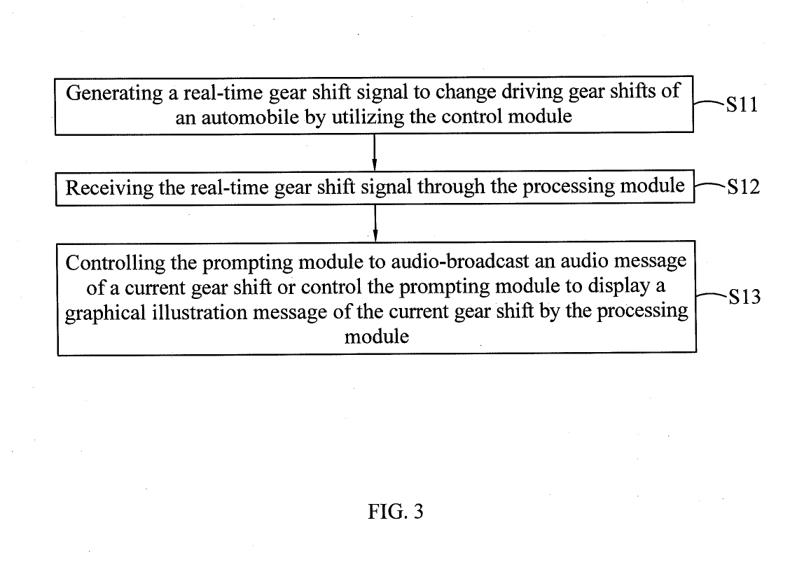

FIG. 3 is a flowchart of a gear shift prompting method according to a first embodiment of the invention. The gear shift prompting method is applied to the gear shift prompting system. The gear shift prompting system can include a navigation device and a control module. The navigation device can include a prompting module and a processing module. The gear shift prompting method comprises the following steps:

In a step S11, generating a real-time gear shift signal to change driving gear shifts of an automobile by utilizing the control module.

In a step S12, receiving the real-time gear shift signal through the processing module.

In a step S13, controlling the prompting module to audio-broadcast an audio message of a current gear shift or control the prompting module to display a graphical illustration message of the current gear shift by the processing module.

The detail depiction and embodiments of the gear shift prompting method in the gear shift prompting system according to the invention have been depicted in the gear shift prompting system of the invention, and there is no need to describe herein.

Next, according to the first embodiment, the invention further provides a second embodiment as a further example.

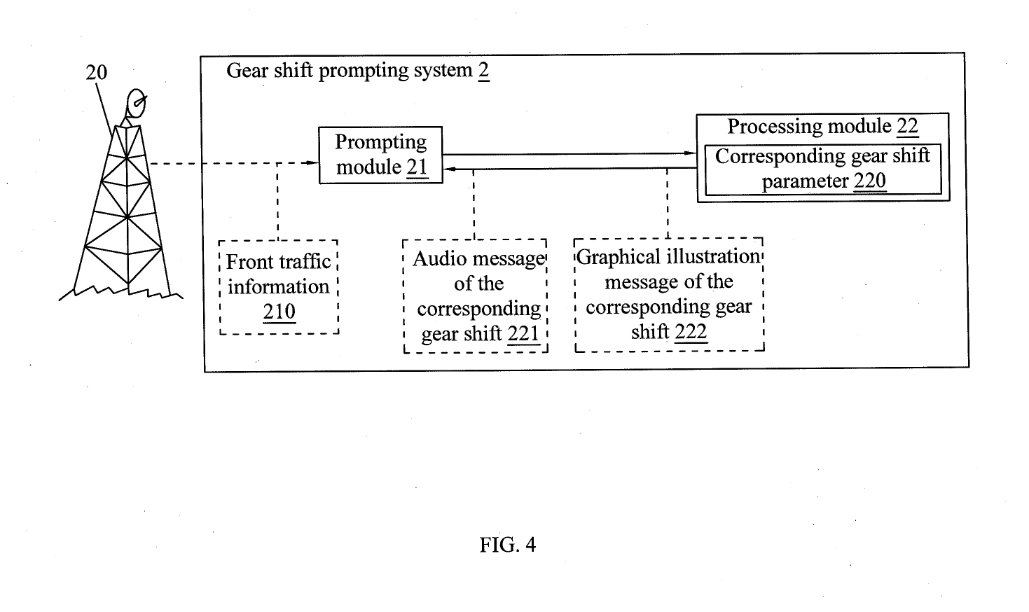

With reference to FIG. 4 for a block diagram of a gear shift prompting system according to a second embodiment of the invention is depicted. As shown in FIG. 4, the gear shift prompting system 2 can be applied to a navigation device and includes the prompting module 21 and the processing module 22. The navigation device can obtain front traffic information 210 through a traffic message channel (TMC) 20 and the front traffic information 210 can be broadcasted on the prompting module 21. The processing module 22 can be a CPU or a micro-processing unit and analyzes a corresponding gear shift parameter 220 based upon front traffic information 210 and controls the prompting module 21 to audio-broadcast the audio message of a corresponding gear shift 221 corresponding to the corresponding gear shift parameter or display the graphical illustration message of the corresponding gear shift 222.

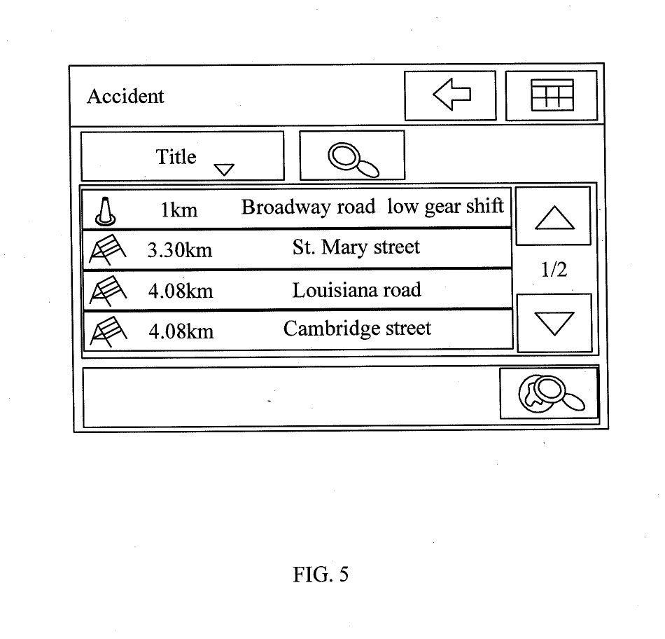

With reference to FIG. 5 for a first schematic diagram of a gear shift prompting system according to a second embodiment of the invention is depicted. As shown in the figure, the processing module can be connected to the prompting module through the CAN bus. Therefore, when the navigation device obtains that a traffic accident happens in front of 1 km (Broadway road) through the traffic message channel (TMC), the processing module can analyze the corresponding gear shift parameter based upon related traffic information in front of 1 km, and the driver can be prompted that the gear shift must be switched to a low speed gear shift displayed by the prompting module. Simultaneously, the prompting module also audio-broadcasts the audio message to advise the driver that the gear shift must be switched to S gear shift or L gear shift based upon the corresponding gear shift parameter. Accordingly, the processing module can control the prompting module to audio-broadcast the audio message of the corresponding gear shift through the CAN bus or display the graphical illustration message of the corresponding gear shift.

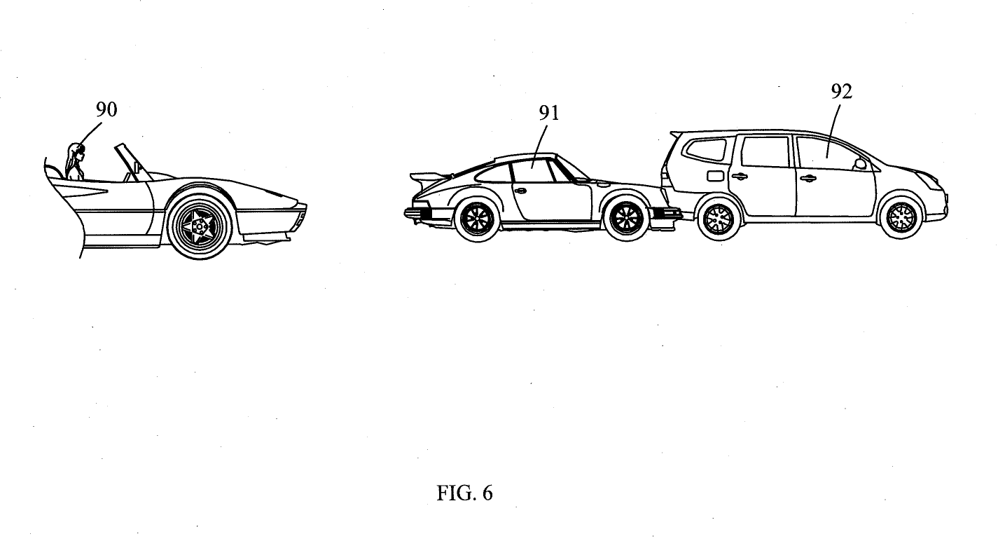

With reference to FIG. 6 for a second schematic diagram of a gear shift prompting system according to a second embodiment of the invention is depicted. As shown in the figure, the navigation device can obtain front traffic information recording the traffic accident through the TMC. Since information flow of roads is great, the processing module of the invention can transmit front traffic information to an external database through a general packet radio service (GPRS) based upon front traffic information. At the same time, since the external database receives front traffic signal to analyze the corresponding gear shift parameter and transmits the corresponding gear shift parameter back to the processing module from the external database. Since rear-end collision between the automobiles 91, 92 happens, the driver 90 does not only obtain the traffic accident through the navigation device but also controls the prompting module to audio-broadcast the audio message of the corresponding gear shift based upon the corresponding gear shift parameter calculated by the external database or display the graphical illustration message of the corresponding gear shift on the prompting module.

The concept of the gear shift prompting method of the invention has been explained during the process of depicting the gear shift prompting system of the invention. However, to further understand the concept, the gear shift prompting method is further depicted in the following flowchart.

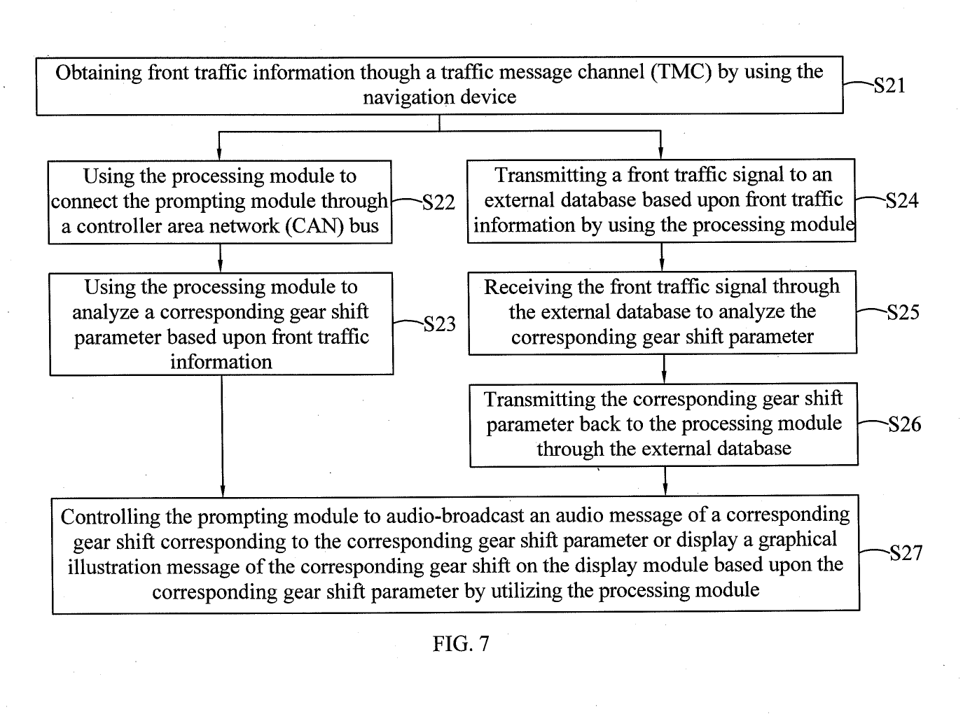

FIG. 7 is a flowchart of a gear shift prompting method according to a second embodiment of the invention is depicted. The gear shift prompting method is applied to a gear shift prompting system. The gear shift prompting system can be suitable for a navigation device, and the navigation device includes a prompting module and a processing module. The gear shift prompting method comprises the following steps:

In a step S21, obtaining front traffic information though a traffic message channel (TMC) by using the navigation device.

In a step S22, using the processing module to connect the prompting module through a controller area network (CAN) bus.

In a step S23, using the processing module to analyze a corresponding gear shift parameter based upon front traffic information.

In a step S24, transmitting a front traffic signal to an external database based upon front traffic information by using the processing module.

In a step S25, receiving the front traffic signal through the external database to analyze the corresponding gear shift parameter.

In a step S26, transmitting the corresponding gear shift parameter back to the processing module through the external database.

In a step S27, controlling the prompting module to audio-broadcast an audio message of a corresponding gear shift corresponding to the corresponding gear shift parameter or display a graphical illustration message of the corresponding gear shift on the display module based upon the corresponding gear shift parameter by utilizing the processing module.

The detail depiction and embodiments of the gear shift prompting method in the gear shift prompting system according to the invention have been depicted in the gear shift prompting system of the invention, and there is no need to describe herein.

The gear shift prompting system and the gear shift prompting method thereof according to the invention have one or more advantages as the following:
1. The gear shift prompting system and the gear shift prompting method thereof of the invention can use the navigation device to display and notify the driver that the gear shift is being switching so that the driver can quickly and accurately understand and is familiar with the gear shift switching of the automobile.
2. The gear shift prompting system and the gear shift prompting method thereof of the invention can use the navigation device to obtain front traffic information real-time through the TMC and notify the driver to shift original gear shifts to properly corresponding gear shifts.
3. The gear shift prompting system and the gear shift prompting method thereof of the invention can provide the corresponding gear shifts to the driver based upon different conditions so that fuel consuming and mechanical consumption of the automobile can be reduced to the minimum, and driving risk can be reduced as well.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A gear shift prompting system comprising:
a control module for generating a real-time gear shift signal to control a vehicle gear shift; and
a navigation device comprising:
a prompting module; and
a processing module for receiving the real-time gear shift signal, and controlling the prompting module to audio-broadcast an audio message of a current gear shift corresponding to the real-time gear shift signal based upon the real-time gear shift signal or controlling the prompting module to display a graphical illustration message of the current gear shift.

2. The gear shift prompting system as recited in claim 1, wherein the navigation device obtains a piece of front traffic information through a traffic message channel (TMC).

3. The gear shift prompting system as recited in claim 2 wherein the processing module analyzes a corresponding gear shift parameter based upon the piece of front traffic information, and controls the prompting module to audio-broadcast an audio message of a corresponding gear shift corresponding to the corresponding gear shift parameter, or controls the prompting module to display a graphical illustration message of the corresponding gear shift.

4. The gear shift prompting system as recited in claim 2 wherein the processing module transmits a front traffic signal to an external database based upon the piece of front traffic information, and the external database receives the front traffic signal to analyze a corresponding gear shift parameter, and the external database transmits the corresponding gear shift parameter back to the processing module.

5. The gear shift prompting system as recited in claim 4 wherein the processing module controls the prompting module to audio-broadcast an audio message of a corresponding gear shift corresponding to the corresponding gear shift parameter based upon the corresponding gear shift parameter, or controls the prompting module to display a graphical illustration message of the corresponding gear shift.

6. The gear shift prompting system as recited in claim 2, wherein the processing module transmits a front traffic signal to an external database through a general packet radio service (GPRS) based upon the piece of front traffic information.

7. The gear shift prompting system as recited in claim 6, wherein the external database receives the front traffic signal to analyze a corresponding gear shift parameter, and transmits the corresponding gear shift parameter back to the processing module, and the processing module controls the prompting module to audio-broadcast an audio message of a corresponding gear shift corresponding to the corresponding gear shift parameter, or controls the prompting module to display a graphical illustration message of the corresponding gear shift based upon the corresponding gear shift parameter.

8. The gear shift prompting system as recited in claim 1, wherein the control module is connected to the navigation device through a controller area network (CAN) bus, and controls the navigation device to audio-broadcast the audio message of the current gear shift corresponding to the real-time gear shift signal, or controls the navigation device to display the graphical illustration message of the current gear shift through the controller area network bus.

9. A gear shift prompting method being suitable for a gear shift prompting system, the gear shift prompting system comprising a navigation device and a control module, the navigation device comprising a prompting module and a processing module, the gear shift prompting method comprising:
generating a real-time gear shift signal to control a vehicle gear shift by utilizing the control module;
receiving the real-time gear shift signal through the processing module; and
controlling the prompting module to audio-broadcast an audio message of a current gear shift corresponding to the real-time gear shift signal or controlling the prompting module to display a graphical illustration message of the current gear shift based upon the real-time gear shift signal by utilizing the processing module.

10. The gear shift prompting method as recited in claim 9, further comprising a step:
obtaining a piece of front traffic information through a traffic message channel (TMC) by using the navigation device.

11. The gear shift prompting method as recited in claim 10, further comprising steps:
analyzing a corresponding gear shift parameter based upon the piece of front traffic information by using the processing module; and
controlling the prompting module to audio-broadcast an audio message of a corresponding gear shift corresponding to the corresponding gear shift parameter or display a graphical illustration message of the corresponding gear shift on the prompting module through the processing module.

12. The gear shift prompting method as recited in claim 10, further comprising steps:
transmitting a front traffic signal to an external database based upon the piece of front traffic information by utilizing the processing module;
receiving the front traffic signal to analyze a corresponding gear shift parameter through the external database; and
transmitting a corresponding gear shift back to the processing module through the external database.

13. The gear shift prompting method as recited in claim 12, further comprising a step:
controlling the prompting module to audio-broadcast an audio message of the corresponding gear shift corresponding to the corresponding gear shift parameter or display a graphical illustration message of the corresponding gear shift based upon the corresponding gear shift parameter by the processing module.

14. The gear shift prompting method as recited in claim 10, further comprising a step:
transmitting a front traffic signal to an external database through a general packet radio service (GPRS) based upon the piece of front traffic information by using the processing module.

15. The gear shift prompting method as recited in claim 14, further comprising steps:
receiving the front traffic signal to analyze a corresponding gear shift parameter through the external database;
transmitting the corresponding gear shift parameter back to the processing module through the external database; and
controlling the navigation device to audio-broadcast an audio message of a corresponding gear shift corresponding to the corresponding gear shift parameter by the processing module, or display a graphical illustration message of the corresponding gear shift on the navigation device based upon the corresponding gear shift parameter.

16. The gear shift prompting method as recited in claim 9, further comprising steps:
connecting the navigation device and the control module through a controller area network (CAN) bus; and
controlling the navigation device to audio-broadcast the audio message of the current gear shift corresponding to the real-time gear shift signal or controlling the navigation device to display the graphical illustration message of the current gear shift through the controller area network bus by utilizing the control module.
